(19) United States
(12) Patent Application Publication
(10) Pub. No.: US 2007/0237161 A1
(43) Pub. Date: Oct. 11, 2007

(54) Multiple logical node apparatus

(75) Inventor: Yukiyo Akisada, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/602,547

(22) Filed: Nov. 20, 2006

(30) Foreign Application Priority Data
Apr. 5, 2006 (JP) 2006-103739

(51) Int. Cl. H04L 12/56

(52) U.S. Cl. 370/400; 719/324

(57) ABSTRACT

A multiple logical node apparatus includes: an OS operated in the multiple logical node apparatus; an application operated under the OS; a physical network device for performing communication with a network medium, which is mounted on the multiple logical node apparatus; a virtual network device implemented by software; a first device driver for controlling the physical network device, being incorporated in the OS; and a second device driver for controlling the virtual network device, being incorporated in the OS.

This application claims foreign priority based on Japanese Patent application No. 2006-103739, filed Apr. 5, 2006, the content of which is incorporated herein by reference in its entirety.

### BACKGROUND OF THE INVENTION

1. Field of the Invention

The present invention relates to a multiple logical node apparatus for realizing a plurality of logical nodes by using a single physical network device and, in particular, relates to a multiple logical node apparatus which can set a different MAC address (Media Access Control address: a physical address uniquely assigned to a network card, etc.) in respective logical nodes.

2. Description of the Related Art

There are related arts associated with a multiple logical node apparatus for realizing a plurality of logical nodes or multiple terminal simulators, such as JP-A-03-147044, JP-A-06-224916, JP-A-09-146886, JP-A-10-069461, JP-A-2000-057096 and JP-A-2004-062700.

FIG. 10 is a diagram showing OSI (Open Systems Interconnection) reference model in which a network system is classified into seven layers to define roles and functions for the respective layers. In FIG. 10, a reference sign “LY01” denotes a physical layer which defines electrical interfaces or the like for physical media. A reference sign “LY02” in FIG. 10 denotes a data link layer which defines a data packetization, a transmission/reception protocol, etc.

Similarly, reference signs “LY03”, “LY04”, “LY05”, “LY06” and “LY07” in FIG. 10 denote a network layer, a transport layer, a session layer, a presentation layer, and an application layer, respectively.

In the network layer, a data transfer protocol between two nodes is defined. A data transfer protocol between processes is defined in the transport layer. A protocol at a session level is defined in the session layer. A data representing format protocol is defined in the presentation layer. A communication protocol at an application level is defined in the application layer.

A process in the network application (hereinafter, simply referred to as process) which operates in a node defined by the OSI reference model as shown in FIG. 10 is, all of the processes are, on the basis of the OSI reference model, regarded as a communication in which an unique IP (Internet Protocol) address and an unique MAC (Media Access Control address: a physical address uniquely assigned to a network card, etc.) are attached.

For example, FIG. 11 is an explanatory diagram for describing a process operation of the network application operated in a node defined by the OSI reference model. In FIG. 11, the unique IP address and unique MAC address of the node are attached to each of the processes indicated by “PR11”, “PR12” and “PR13”, when each of communication “CM11”, “CM12” and “CM13” is carried out through the respective layers “LY07” to “LY01” shown in FIG. 11.

As a result, in the case of a single node, the communication data to which the unique IP address and unique MAC address of the single node are attached is transmitted when a plurality of processes communicates from one another.

Further, JP-A-2004-062700 discloses an invention for simulating a plurality of nodes in such a way that communication is carried out by using an arbitrary IP address for each process in a single node. FIG. 12 is an explanatory diagram for describing one example of the related art.

In FIG. 12, reference signs “LY01” to “LY07” of FIG. 10 are commonly used. Reference signs “VN21”, VN22” and “VN23” denote virtual nodes for controlling the application layer (“LY07”) to network layer (“LY03”) by the respective processes.

In FIG. 12, the virtual nodes indicated by “VN21”, “VN22” and “VN23” are independent from one another, and an arbitrary IP address corresponding to the individual process is attached in the communication of each of the processes for controlling the respective virtual nodes.

FIG. 13 is an explanatory diagram for describing an operation for the one example of the related art described above. In FIG. 13, reference signs “LY01”, “LY02”, “VN21”, “VN22” and “VN23” of FIG. 12 are commonly used, and “PR31”, “PR32” and “PR33” denote processes.

For example, when the communications “CM31”, “CM32” and “CM33” shown in FIG. 13 are carried out, the respective communications are performed in the virtual nodes indicated by “VN21”, “VN22” and “VN23” in FIG. 12 as far as the network layer (“LY03”), and the unique IP addresses of the virtual nodes are attached to the processes indicated by “PR31”, “PR32” and “PR33” in FIG. 13, respectively.

Further, for example, the unique MAC address of the single node is attached when the communication passes through the data link layer indicated by “LY02” in FIG. 13.

For example, when the processes indicated by “PR31”, “PR32” and “PR33” carry out communications “CM31”, “CM32” and “CM33” shown in FIG. 13, communication data are represented as “CD41”, “CD42” and “CD43” shown in FIG. 14, respectively.

FIG. 14 is an explanatory diagram showing one example of communication data structure in which communication data “CD41” is constituted by a MAC address “MAC001”, an IP address “IP001” and communication data “DT001”.

Similarly, communication data “CD42” in FIG. 14 is constituted by a MAC address “MAC001”, an IP address “IP002” and communication data “DT002”. Communication data “CD43” is also constituted by a MAC address “MAC001”, an IP address “IP003” and communication data “DT003”.

That is, the different IP address (“IP001” to “IP003”) is attached to every process, and communication data to which the unique MAC address (“MAC001”) of the single node is attached is transmitted to a network medium such as a communication cable.

As a result, the arbitrary IP address is attached to every process with respect to the single node in such a way that a plurality of virtual nodes for controlling from the application layer to the network layer by the individual process are provided for every process to be operated on the single node. The communication data to which the unique MAC address of the single node is attached is then transmitted to the network medium such as a communication cable.

Furthermore, network devices such as a plurality of network cards are provided simply for the single node, therefore, communication data to which an arbitrary IP address and an arbitrary MAC address are attached to every network device can be transmitted to the network medium such as a communication cable.

FIG. 15 is a structural block diagram showing one example of a node in a case where the network devices such as the plurality of network cards are provided for the aforementioned single node. In FIG. 15, a reference numeral 1 denotes a single node; 2 denotes an OS (Operating System: hereinafter, simply referred to as OS) to be operated in the node 1; 3 denotes an application to be operated under the OS 2; 4 and 5 denote device drivers; 6 and 7 denote network devices such as a network card; and 8 denotes a network medium such as a communication cable.

The physical network devices 6 and 7 such as network cards are mounted on the node 1 and both connected to the network media 8.

On the contrary, the OS 2 is operated in the node 1. The application 3 constituted by a plurality of processes is also operated under the OS 2. In addition, the device drivers 4 and 5 are incorporated in the OS 2 by which the physical network devices 6 and 7 are controlled through the device drivers 4 and 5.

The application 3, OS 2, device drivers 4 and 5 fulfill roles and functions corresponding to from the application layer (“LY07”) to the data link layer (“LY02”) in the OSI reference model. The network devices 6 and 7 fulfill roles and functions corresponding to the physical layer (“LY01”).

Here, the operation shown in FIG. 15 will be explained with use of FIG. 16 and FIG. 17, in which FIG. 16 is an explanatory diagram for describing a communication flow, and FIG. 17 is an explanatory diagram indicating one example of a communication data structure.

In FIG. 16, reference numerals 1 to 8 shown in FIG. 15 are commonly used. The communication data flows into the network device 6 through the device driver 4 when communication “CM51” is carried out as shown in FIG. 16. Therefore, a unique IP address of the network device 6 is attached to the communication data and a unique MAC address of the network device 6 is attached to the communication data in the device driver 4.

On the contrary, the communication data flows into the network device 7 through the device driver 5 when the communication “CM52” is carried out as shown in FIG. 16. Therefore, the unique IP address of the network device 7 is attached to the communication data and the unique MAC address of the network device 7 is attached to the communication data in the device driver 5.

In this way, when the communication “CM51” and “CM52” are carried out as shown in FIG. 16, the communication data are represented as “CD61” and “CD62” shown in FIG. 17.

In FIG. 17, the communication data indicated by “CD61” is constituted by a MAC address “MAC101”, an IP address “IP101” and communication data “DT101”. Similarly, the communication data indicated by “CD62” is constituted by a MAC address “MAC102”, an IP address “IP102” and communication data “DT102”.

In this case, reference signs “MAC101” and “IP101” in FIG. 17 are unique values for the physical network device 6. Reference signs “MAC102” and “IP102” in FIG. 17 are unique values for the physical network device 7. Therefore, communication data to which an arbitrary IP address and an arbitrary MAC address are attached to every physical network device can be transmitted to the network medium such as a communication cable.

However, in the case of the related art described in JP-A-2004-062700, for a purpose of simulating the plurality of nodes, even if a different arbitrary IP address in each of the virtual nodes (specifically, the network layer) is attached to the communication for the process operated in the single node, the same MAC address (an unique MAC address of the single node) is attached to the communication in the data link layer. Therefore, this communication is processed as communication of the single node in the network medium such as a communication cable. For this reason, there arises a problem that the communication cannot be dealt with the same as that of the plurality of nodes that is actually performed.

Further, in the case of the example shown in FIG. 15, the communication data to which the arbitrary IP address and arbitrary MAC address is attached for every physical network device can be transmitted to the network medium such as a communication cable. However, the physical network devices must be mounted for a number of necessary nodes. There arises a problem such as cost increase when the plurality of nodes are simulated by the single node.

### SUMMARY OF THE INVENTION

The present invention has been made in view of the above circumstances, and provides a multiple logical node apparatus which can set different MAC addresses for the respective logical nodes.

In some implementations, a multiple logical node apparatus of the invention comprising:

an operating system operated in the multiple logical node apparatus;

an application operated under the operating system;

a physical network device for performing communication with a network medium, the physical network device being mounted on the multiple logical node apparatus;

at least one virtual network device implemented by software;

a first device driver for controlling the physical network device, the first device driver being incorporated in the operating system; and

at least one second device driver for controlling the virtual network device, the second device driver being incorporated in the operating system,

wherein a first process in the application selects the physical network device as a network device for transmitting communication data,

a second process in the application selects the virtual network device as a network device for transmitting communication data, and

the communication data from the virtual network device is transmitted to the network medium by using a communication section of the physical network device, the communication section communicating with the network medium.

Thus, communication data to which an arbitrary IP address and an arbitrary MAC address are attached for every physical network device or virtual network device can be transmitted to the network medium such as a communication cable.

The multiple logical node apparatus of the invention comprising:

a plurality of pairs of the virtual network device and the second device driver.

Thus, communication data to which an arbitrary IP address and an arbitrary MAC address are attached for every physical network device or virtual network device can be transmitted to the network medium such as a communication cable.

In the multiple logical node apparatus of the invention,

a process in the application selects the physical network device or the virtual network device to transmit communication data,

the operating system attaches a unique IP (Internet Protocol) address of the selected physical network device or virtual network device, to a header of the communication data,

the first device driver attaches a unique MAC (Media Access Control) address of the physical network device to the header of the communication data when the physical network device is selected,

the second device driver attaches a unique MAC address of the virtual network device to the header of the communication data when the virtual network device is selected, and

the selected physical network device or virtual network device transmits the communication data to the network medium.

Thus, communication data to which an arbitrary IP address and an arbitrary MAC address are attached for every physical network device or virtual network device can be transmitted to the network medium such as a communication cable.

In some implementations, a multiple logical node apparatus of the invention comprising:

an operating system operated in the multiple logical node apparatus;

an application operated under the operating system;

a physical network device for performing communication with a network medium, the physical network device being mounted on the multiple logical node apparatus;

a first and a second virtual network device which are implemented by software;

a first device driver for controlling the first virtual network device, the first device driver being incorporated in the operating system; and

a second device driver for controlling the second virtual network device, the second device driver being incorporated in the operating system,

wherein a first process in the application selects the first virtual network device as a network device for transmitting communication data,

a second process in the application selects the second virtual network device as a network device for transmitting communication data, and

the communication data from the first and the second virtual network device are respectively transmitted to the network medium by using a communication section of the physical network device, the communication section communicating with the network medium.

Thus, communication data to which an arbitrary IP address and an arbitrary MAC address are attached for every virtual network device can be transmitted to the network medium such as a communication cable.

In the multiple logical node apparatus of the invention,

a process in the application selects the first or the second virtual network device to transmit communication data,

the operating system attaches a unique IP (Internet Protocol) address of the selected first or second virtual network device, to a header of the communication data,

the first device driver attaches a unique MAC (Media Access Control) address of the first virtual network device to the header of the communication data when the first virtual network device is selected,

the second device driver attaches a unique MAC address of the second virtual network device to the header of the communication data when the second virtual network device is selected, and

the selected first or second virtual network device transmits the communication data to the network medium.

Thus, communication data to which an arbitrary IP address and an arbitrary MAC address are attached for every virtual network device can be transmitted to the network medium such as a communication cable.

In the multiple logical node apparatus of the invention,

the first device driver is incorporated in the operating system through a network layer having first node type information, and

the second device driver is incorporated in the operating system through a network layer having second node type information.

The node type information may indicate whether the node is a router or a host.

Thus, communication data to which an arbitrary IP address and an arbitrary MAC address are attached for every physical network device or virtual network device can be transmitted to the network medium such as a communication cable. In addition, a plurality of logical nodes having different node type information can be developed because the node type information can be set in every network device.

The multiple logical node apparatus of the invention comprising:

a plurality of pairs of the virtual network device and the second device driver.

Thus, communication data to which an arbitrary IP address and an arbitrary MAC address are attached for every physical network device or virtual network device can be transmitted to the network medium such as a communication cable. In addition, a plurality of logical nodes having different node type information can be developed because the node type information can be set in every network device.

In the multiple logical node apparatus of the invention,

the operating system determines whether the virtual network device receives a neighbor solicitation when the multiple logical node apparatus receives the neighbor solicitation,

the operating system sets a node type indicator (called IsRouter flag) for a neighbor advertisement based on the first node type information corresponding to the physical network device when the operation system determines that the physical network device receives the neighbor solicitation,

the operating system sets the node type indicator (called IsRouter flag) for the neighboring advertisement based on the second node type information corresponding to the virtual network device when the operation system determines that the virtual network device receives the neighbor solicitation, and

the physical network device or the virtual network device transmits the neighbor advertisement to the network medium.

Thus, communication data to which an arbitrary IP address and an arbitrary MAC address are attached for every physical network device or virtual network device can be transmitted to the network medium such as a communication cable. In addition, a plurality of logical nodes having different node type information can be developed because the node type information can be set in every network device.

In the multiple logical node apparatus of the invention,

the first device driver is incorporated in the operating system through a network layer having first node type information, and

the second device driver is incorporated in the operating system through a network layer having second node type information.

Thus, communication data to which an arbitrary IP address and an arbitrary MAC address are attached for every virtual network device can be transmitted to the network medium such as a communication cable. In addition, a plurality of logical nodes having different node type information can be developed because the node type information can be set in every network device.

In the multiple logical node apparatus of the invention,

the operating system determines whether the first virtual network device receives a neighbor solicitation when the multiple logical node apparatus receives the neighbor solicitation,

the operating system sets a node type indicator (called IsRouter flag) for a neighbor advertisement based on the first node type information corresponding to the first virtual network device when the operation system determines that the first virtual network device receives the neighbor solicitation,

the operating system sets the node type indicator (called IsRouter flag) for the neighboring advertisement based on the second node type information corresponding to the second virtual network device when the operation system determines that the second virtual network device receives the neighbor solicitation, and

the first or the second virtual network device transmits the neighbor advertisement to the network medium.

Thus, communication data to which an arbitrary IP address and an arbitrary MAC address are attached for every virtual network device can be transmitted to the network medium such as a communication cable. In addition, a plurality of logical nodes having different node type information can be developed because the node type information can be set in every network device.

In the multiple logical node apparatus of the invention,

the application is executed in accordance with a model that includes:
a physical layer in an OSI (Open Systems Interconnection) reference model; and
a plurality of logical nodes being provided on a higher-level of the physical layer, and

the plurality of logical nodes respectively serve as from an application layer to a data link layer in the OSI reference model, for every process in the application.

### BRIEF DESCRIPTION OF THE DRAWINGS

FIG. 1 is a structural block diagram showing an embodiment of the multiple logical node apparatus according to the present invention.

FIG. 2 is an explanatory diagram for describing the operation of the embodiment.

FIG. 3 is an explanatory diagram for describing the operation of the embodiment.

FIG. 4 is a flow chart for describing the operation of a node as the multiple logical node apparatus.

FIG. 5 is an explanatory diagram for describing a communication flow.

FIG. 6 is an explanatory diagram showing one example of a communication data structure.

FIG. 7 is an explanatory diagram showing node type information.

FIG. 8 is a structural block diagram showing another embodiment of the multiple logical node apparatus according to the present invention.

FIG. 9 is a flow chart for describing the operation of a node as the multiple logical node apparatus.

FIG. 10 is an OSI (Open Systems Interconnection) reference model.

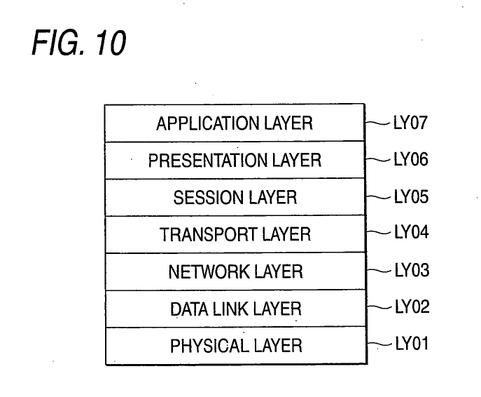

FIG. 11 is an explanatory diagram for describing the operation of processes constituted of a network application operated on a node defined in the OSI reference model.

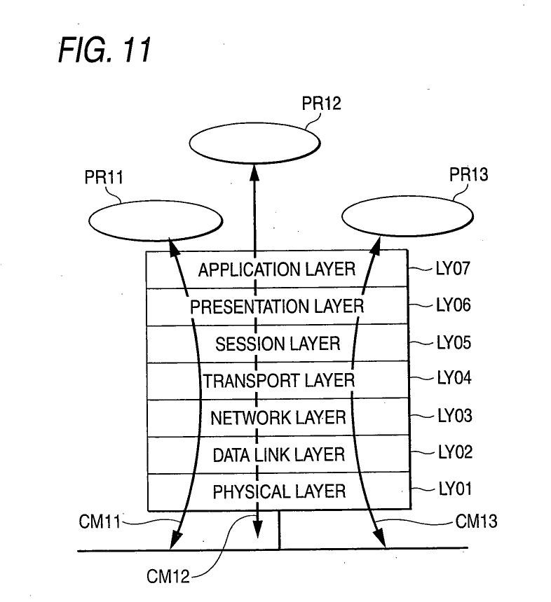

FIG. 12 is an explanatory diagram for describing one example of the related art.

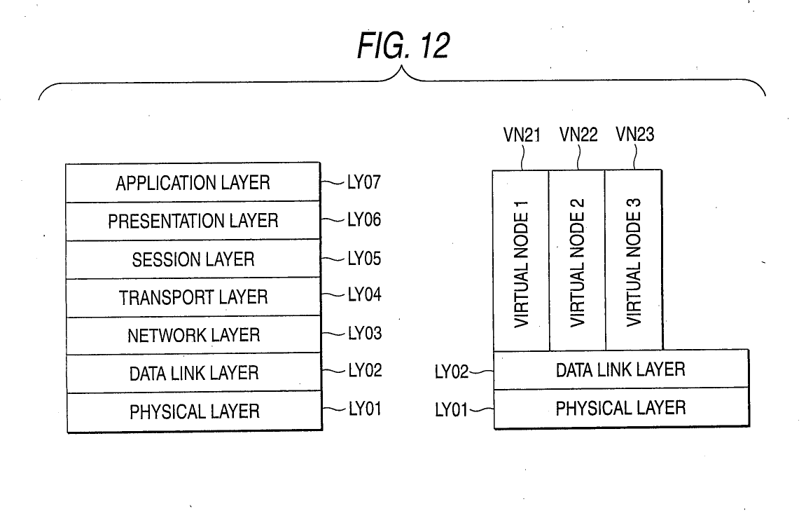

FIG. 13 is an explanatory diagram for describing the operation of one example of the related art.

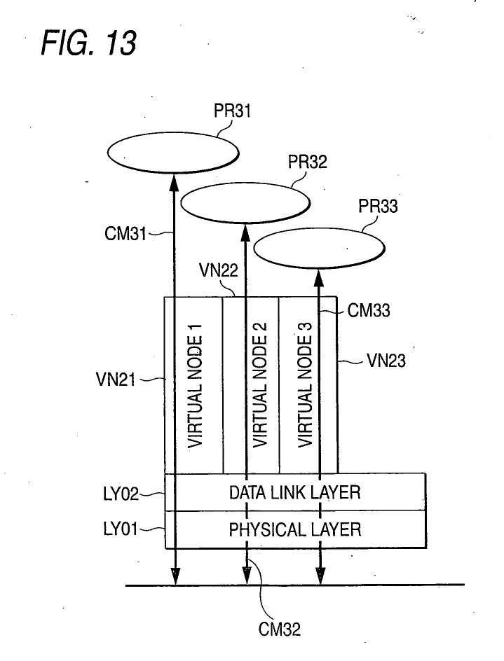

FIG. 14 is an explanatory diagram showing one example of a communication data structure.

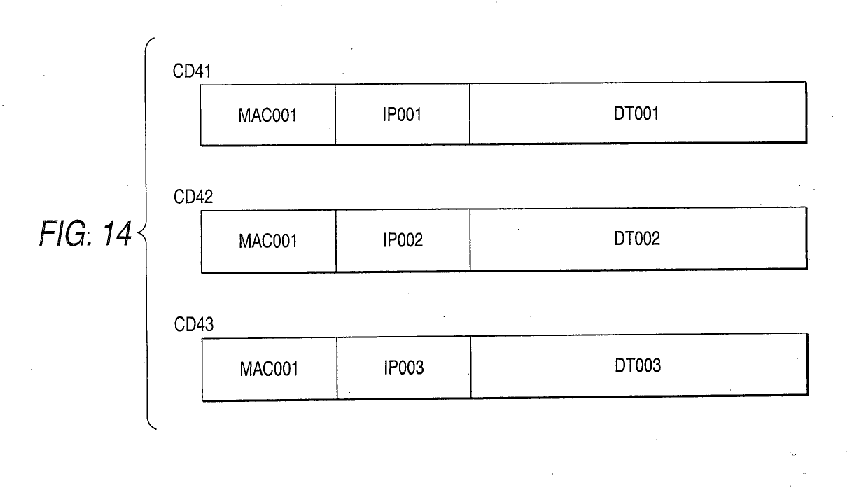

FIG. 15 is a structural block diagram showing one example of a node in the case where a plurality of network devices are provided for a single node.

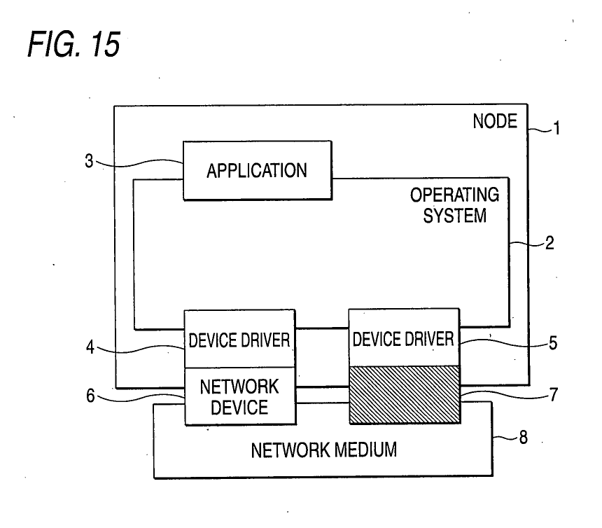

FIG. 16 is an explanatory diagram for describing a communication flow.

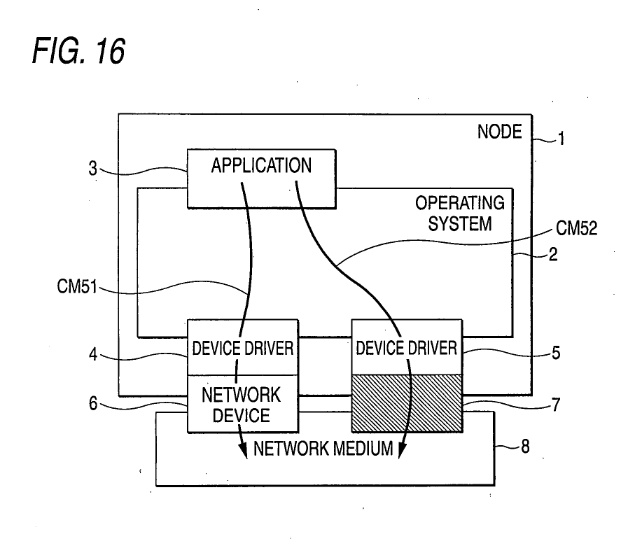

FIG. 17 is an explanatory diagram showing one example of a communication data structure.

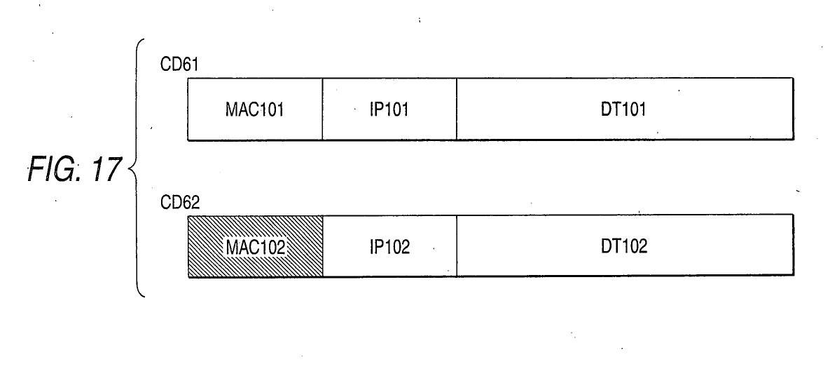

### DESCRIPTION OF THE PRFERRED EMBODIMENTS

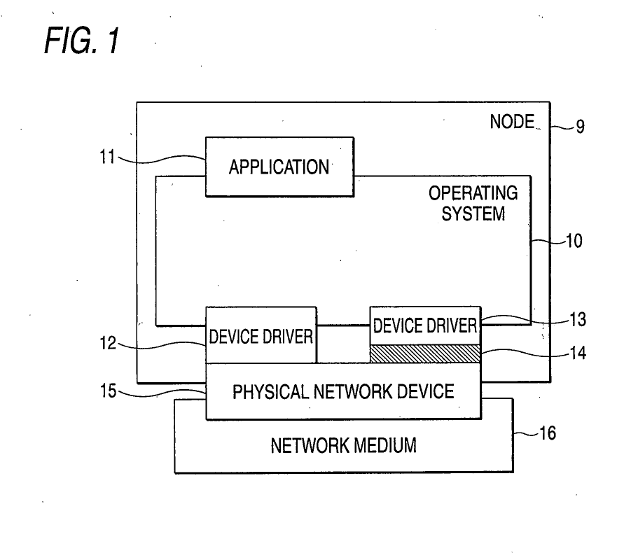

Hereinafter, the invention will be explained in detail with reference to the drawings. FIG. 1 is a structural block diagram showing an embodiment of a multiple logical node apparatus in relation to the invention.

In FIG. 1, a reference numeral 9 denotes a single node as a multiple logical node apparatus, 10 denotes an OS to be operated in the node 9, 11 denotes an application to be operated under the OS 10; 12 and 13 denote device drivers, 14 denotes logical virtual network device implemented by software, 15 denotes a physical network device such as a single physical network card, and 16 denotes a network medium such as a communication cable.

The network device 15 such as a physical network card is mounted on the node 9 and connected to the network medium 16.

On the other hand, the OS 10 is operated in the node 9. The application 11 constituted by a plurality of processes are also operated under the OS 10. Further, the device drivers 12 and 13 are incorporated in the OS 10, and the logical virtual network device 14 is also incorporated in the device driver 13.

The OS 10 then controls the physical network device 15 through the device driver 12, and also controls the logical virtual network device 14 through the device driver 13. At this time, the virtual network device 14 is related, like a bridge, to the physical network device 15 so that communication data from the virtual network device 14 is transmitted to the network medium 16 through the physical network device 15.

Incidentally, the aforementioned bridge means that the virtual network device 14 transmits communication data to which a unique IP address and a unique MAC address of the virtual network device 14 are attached to the network medium 16 by utilizing only a communication function (communication section) for communicating with the network medium 16 of the physical network device 15, regardless of a unique IP address and a unique MAC address of the physical network device 15.

The application 11, OS 10, device driver 12, device driver 13 and virtual network device 14, fulfill roles and functions corresponding to from an application layer (“LY07”) to a data link layer (“LT02”) in an OSI reference model. The physical network device 15 also fulfills roles and functions corresponding to a physical layer (“LY01”).

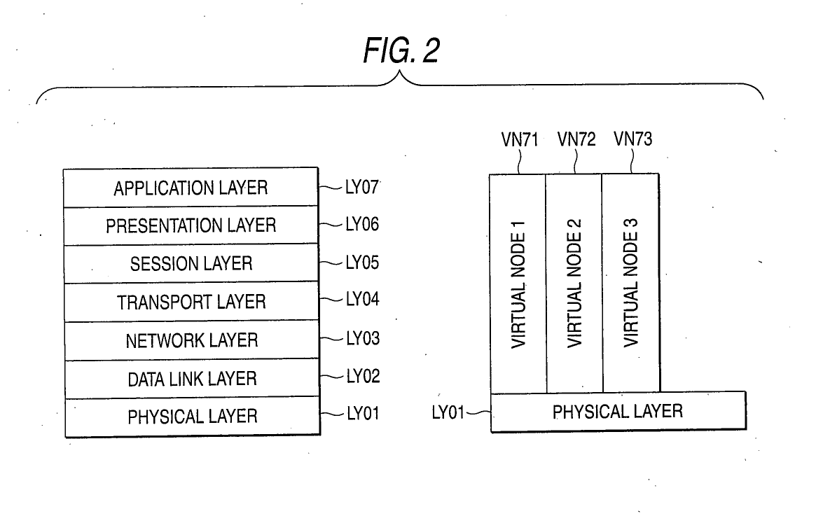

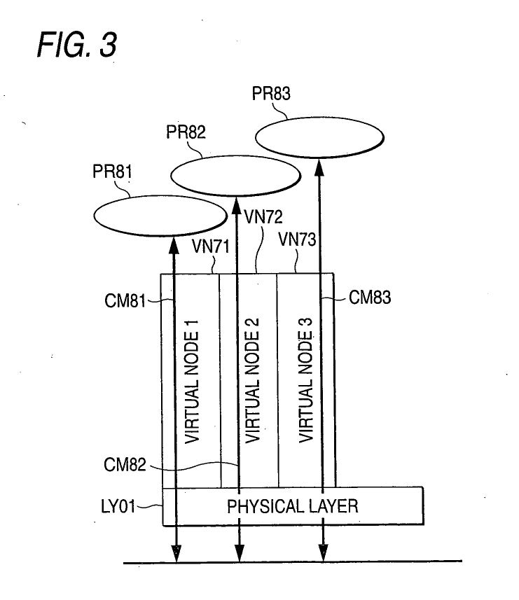

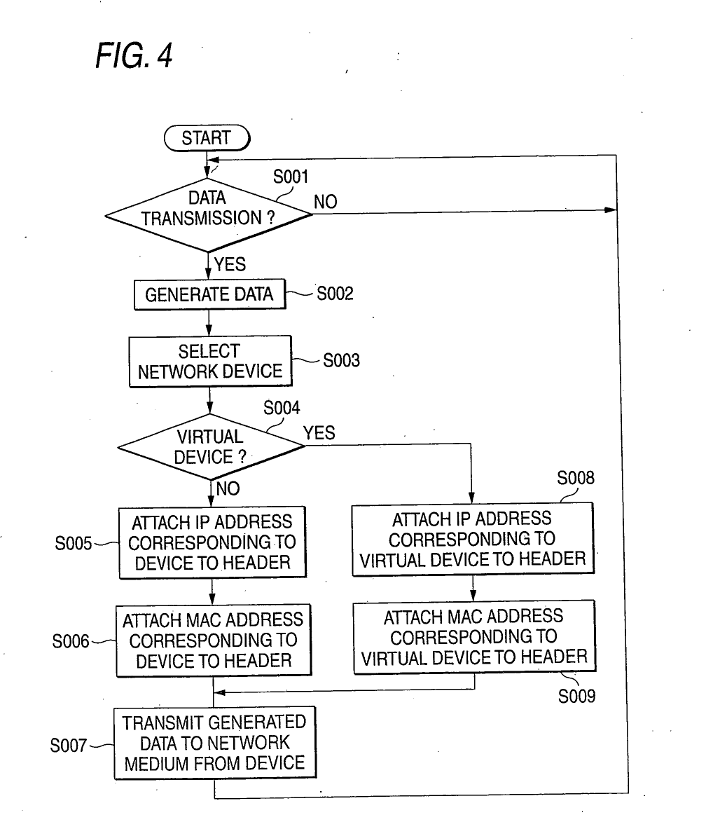

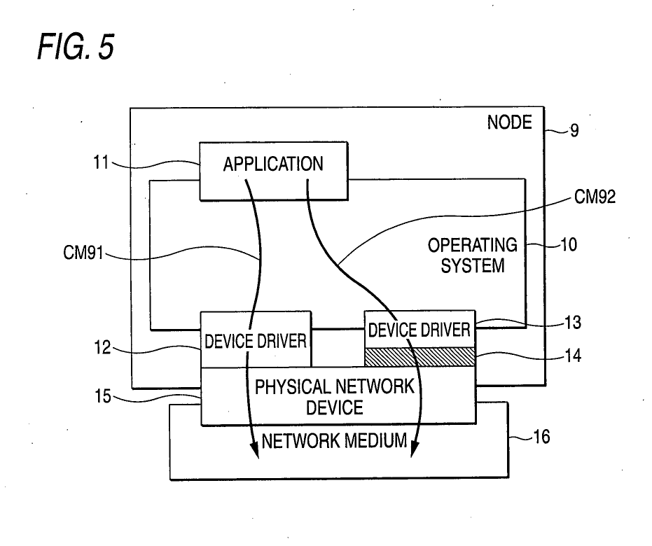

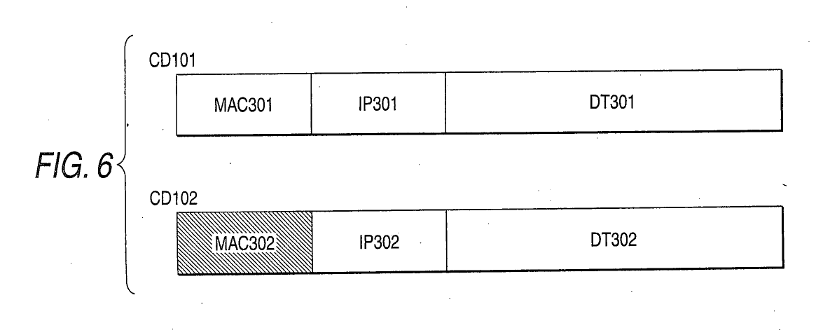

Here, the operation of the embodiment shown in FIG. 1 will be explained with reference to FIG. 2, FIG. 3, FIG. 4, FIG. 5 and FIG. 6. FIG. 2 and FIG. 3 are explanatory diagrams for describing the operation of the embodiment. FIG. 4 is a flow chart for describing the operation of the node 9 as a multiple logical node apparatus. FIG. 5 is an explanatory diagram for describing a communication flow. FIG. 6 is an explanatory diagram showing one example of a communication data structure.

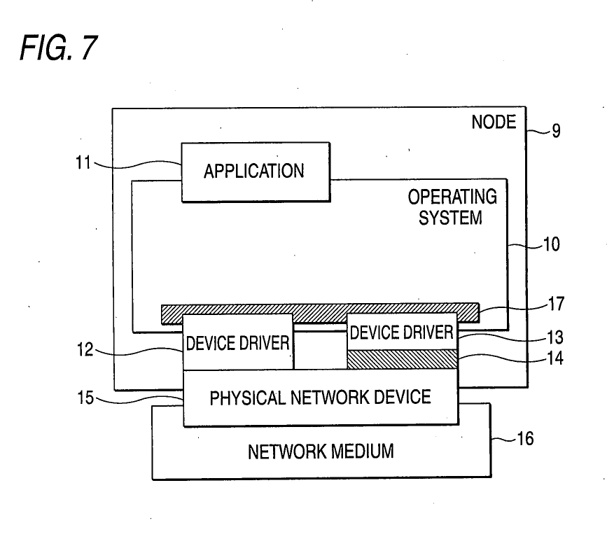

In FIG. 2, reference signs “LY01” to “LY07” shown in FIG. 7 are commonly used. In FIG. 2, reference signs “VN71”, “VN72” and “VN73” denote virtual nodes (logical nodes) each for controlling from the application layer (“LY07”) to the data link layer (“LY02”) by an individual process.

The virtual nodes (logical nodes) as indicated by “VN71”, “VN72” and “VN73” in FIG. 2 are independent from one another. An arbitrary IP address and an arbitrary MAC address both corresponding to the respective processes are attached to communication data in the processes for controlling the respective virtual nodes.

In FIG. 3, reference signs “LY01”, “VN71”, “VN72” and “VN73” shown in FIG. 2 are commonly used, and reference signs “PR81”, “PR82” and “PR83” denote processes constituting the application 11.

For example, in the processes in the application 11 indicated by “PR81”, “PR82” and “PR83” in FIG. 3, when communications indicated by “CM81”, “CM82” and “CM83” in FIG. 3 are carried out, individual communication is handled in the virtual nodes (logical nodes) indicated by “VN71”, “VN72” and “VN73” in FIG. 3 up to the data link layer (“LY02”). Respective unique IP addresses of the virtual nodes (logical nodes) are attached to the processes, and respective unique MAC addresses of the virtual nodes (logical nodes) are also attached to the processes, respectively.

The aforementioned communication operation will be explained further with reference to FIG. 4. In a step “S001” in FIG. 4, the node 9 (specifically, the respective processes constituting the application 11) checks on whether a data transmission is carried out when determining that the data transmission is to be carried out, the node 9 generates data for the transmission in a step “S002”. In a step “S003”, the node 9 (specifically, respective processes constituting the application 11) selects a network device (the virtual network device 14 or the physical network device 15) for transmitting the generated data.

As described above, the respective virtual nodes (logical nodes) from the application layer (“LY07”) to the data link layer (“LY02”) are logically formed in such a way that the node 9 (specifically, the respective processes constituting the application 11) selects a network device for transmitting the communication data.

In a step “S004”, if the node 9 (specifically, the OS 10) determines that the virtual network device 14 is not selected, in other words, the physical network device 15 is selected, the node 9 (specifically, the OS 10) attaches a unique IP address of the physical network device 15 to a header of the communication data in a step “S005”. The node 9 (specifically, the device driver 12) also attaches a unique MAC address of the physical work device 15 to the header of the communication data in a step “S006”.

On the contrary, if the node 9 (specifically, the OS 10) determines that the virtual network device 14 is selected in the step “S004”, the node 9 (specifically, the OS 10) attaches a unique IP address of the virtual network device 14 to the header of the communication data in a step “S008”. The node 9 (specifically, the device driver 13) attaches a unique MAC address of the virtual network device 14 to the header of the communication data in a step “S009”.

Finally, in a step “S007”, the node 9 (specifically, the physical network device 15 or the virtual network device 14) transmits the generated communication data to the network medium 16.

In FIG. 5, reference numerals 9 to 16 are the same as those annexed to FIG. 1. When a predetermined process constituting the application 11 carries out a communication indicated by “CM91” in FIG. 5, the communication data is flown into the physical network device 15 through the device driver 12. Therefore, the unique IP address of the physical network device 15 is attached to the communication data, and the unique MAC address of the physical network device 15 to the communication data in the device driver 12.

On the contrary, when a predetermined process constituting the application 11 carries out a communication as “CM92” shown in FIG. 5, the communication data flows into the virtual network device 14 through the device driver 13. A unique IP address of the virtual network device is then attached to the communication data, and a unique MAC address of the virtual network device 14 is attached to the communication data, in the device driver 13.

Furthermore, the communication data from the virtual network device 14 is transmitted to the network medium 16 by utilizing only a communication function (communication section) for communicating with the network medium 16 of the physical network device 15.

In this way, when the predetermined process constituted of the application 11 carries out the communication as “CM91” and “CM92” shown in FIG. 5, the communication data are represented by “CD101” and “CD102” as shown in FIG. 6.

The communication data “CD101” shown in FIG. 6 is constituted by a MAC address “MAC301”, an IP address “IP301” and communication data “DT301”. Similarly, the communication data “CD102” in FIG. 6 is constituted by a MAC address “MAC302”, an IP address “IP302” and communication data “DT302”.

In this case, “MAC301” and “IP301” in FIG. 6 are unique values with respect to the physical network device 15. “MAC302” and “IP302” in FIG. 6 are unique values with respect to the virtual network device 14. Communication data to which the arbitrary IP address and the arbitrary MAC address are attached for every either physical network device or virtual network device can be transmitted to the network medium such a communication cable.

In other words, the respective processes constituting the application 11 select a different network device (physical network device 15 or virtual network device 14) for a purpose of transmitting the communication data. Hereby, the communication data to which the arbitrary IP address and the arbitrary MAC address are attached for every physical network device or virtual network device can be transmitted to the network medium such as a communication cable.

As a result, the single physical network device is mounted on a single node and controlled by a first network driver. The virtual network device is controlled by a second network deriver. The communication data from the virtual network device is transmitted to the network medium by utilizing only the communication function (communication section) for communicating with the network medium of the physical network device. The communication data to which the arbitrary IP address and the arbitrary MAC address are attached for every physical network device or virtual network device can therefore be transmitted to the network medium such as a communication cable.

That is, the respective processes constituting the application 11 select the different network device (physical network device 15 or virtual network device 14) for the purpose of transmitting the communication data. Hereby, the respective virtual nodes (logical nodes) are formed, and a different MAC address can be set in the respective virtual nodes (logical nodes).

Further, the virtual network device is implemented by software. Therefore, arbitrary number of the virtual network devices can be incorporated in the OS regardless of the number of the physical network devices, so that cost increase can be reduced.

Furthermore, the virtual network device is controlled by the OS 10 through the device driver, therefore, can be handled as an ordinary physical network device. For this reason, the application operated in the node can use a plurality of virtual nodes (logical nodes) without using a particular kind of API (Application Program Interface).

Further, the MAC address is controlled by the device drivers of the respective pairs. Therefore, a different MAC address can be set in each of the virtual network devices.

Incidentally, in the embodiment shown in FIG. 1, for a purpose of making simplicity for the description, the device driver 12 and a pair of the device driver 13 and virtual work device 14 are incorporated in the OS 10. Of course, pairs of the device driver 13 and virtual network device 14 are incorporated in the OS 10 for a number of the virtual nodes (logical nodes) necessary for the simulation.

Further, in the embodiment shown in FIG. 1, the device driver 12 for directly controlling the physical network device 15 is incorporated in the OS 10. Of course, the virtual network device is incorporated in the all device drives, the virtual network devices are controlled through the respective device drivers, and the respective virtual network devices may be bridged to the single physical network device.

Further, the arbitrary number of virtual nodes (logical nodes) can be simulated in the single node without using a particular kind of API. This application can therefore be made for a conformance tester of a higher-layer protocol usage in network devices.

Further, when IPv6 (Internet Protocol version 6) is used as the network layer, a neighbor discovery function which is a unique function of the IPv6 is used in a mapping for an network layer address and a data link layer address.

In the neighbor discovery function, the behavior is different depending on whether the node is a host or a router. Thus, there is a necessity for indication whether the node is a host or router.

For this reason, a certain node transmits a neighbor solicitation (a packet for inquiring the data link layer address) to a multicast address by using the neighbor discovery function. A node to respond to the neighbor solicitation sends a neighbor advertisement (a packet having a node indicator (flag) indicating a host or a router other than the data link layer address) back to the node which has transmitted the neighbor solicitation.

The node receiving a neighbor response can identify whether the node is a host or a router by checking the node indicator contained in the neighbor response.

More specifically, if the value of node indicator (flag) is true, the node is indicated as a router. If the value of node indicator (flag) is false, the node is indicated as a host. Therefore, the node receiving the neighbor response can identify the node whether it is a host or a router by judging the node indicator (flag) which indicates true or false.

Node type information for setting the node indicator (flag) as described above is held in the network layer on every node unit. FIG. 7 is an explanatory diagram for describing the aforementioned node type information. Reference numerals 9, 10, 11, 12, 13, 14, 15, and 16 are the same as those annexed to FIG. 1. A reference numeral 17 denotes the node type information held in the network layer.

The application 11, OS 10, device driver 12, device driver 13, virtual network device 14, and node type information 17 fulfill roles and functions corresponding to from the application layer (“LY07”) to the data link layer (“LY02”) in the OSI reference model.

Further, the connection and incorporation relations in FIG. 7 are basically the same as those in the embodiment shown in FIG. 1. The different point from FIG. 1 is that the device drivers 12 and 13 are incorporated in the OS 10 through the network layer (network layer operates by the application 11, OS 10, and node type information 17) having the node type information 17.

In the explanatory diagram of FIG. 7, as aforementioned, communication data to which an arbitrary IP address and an arbitrary MAC address are attached for every physical network device or virtual network device can be transmitted to the network medium such as a communication cable. A multiple logical node apparatus capable of setting a different MAC address in respective logical nodes can therefore be realized.

In this regard, the node type information 17 is single information even for the physical network device or virtual network device. Even if the communication data to which the arbitrary IP address and the arbitrary MAC address are attached for every physical network device or virtual network device is transmitted to the network medium such as a communication cable, the node can only serve as either the host or router.

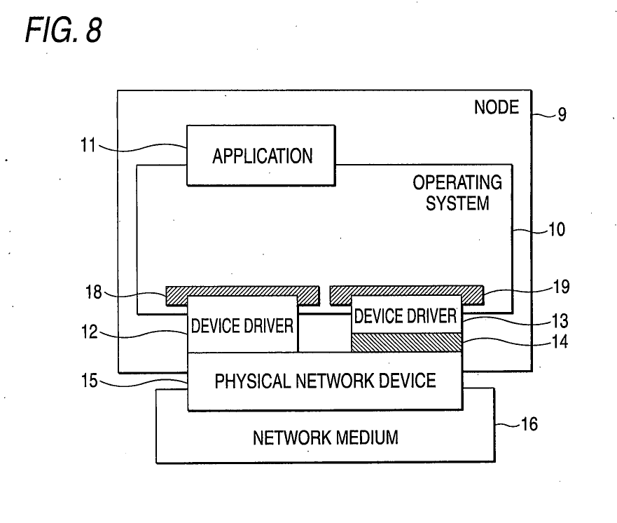

FIG. 8 is a structural block diagram showing another embodiment of the multiple logical node apparatus according to the invention considering the IPv6.

In FIG. 8, reference numerals 9, 10, 11, 12, 13, 14, 15, and 16 shown in FIG. 1 are commonly used. Reference numerals 18 and 19 denote node type information held in the network layer.

The application 11, OS 10, device driver 12, device driver 13, virtual network device 14, node type information 18 and 19 fulfill roles and functions corresponding to from the application layer “(LY07”) to the data link layer (“LY02”) in the OSI reference model.

Further, the connection and incorporation relations in FIG. 8 are basically the same as those in the embodiment shown in FIG. 1. The different point from FIG. 1 is that the device drivers 12 is incorporated in the OS 10 through the network layer (network layer operates by the application 11, OS 10 and node type information 18) having the node type information 18, and the device driver 13 is incorporated in the OS 10 through the network layer (network layer operates by the application 11, OS 10, and node type information 19) having the node type information 19.

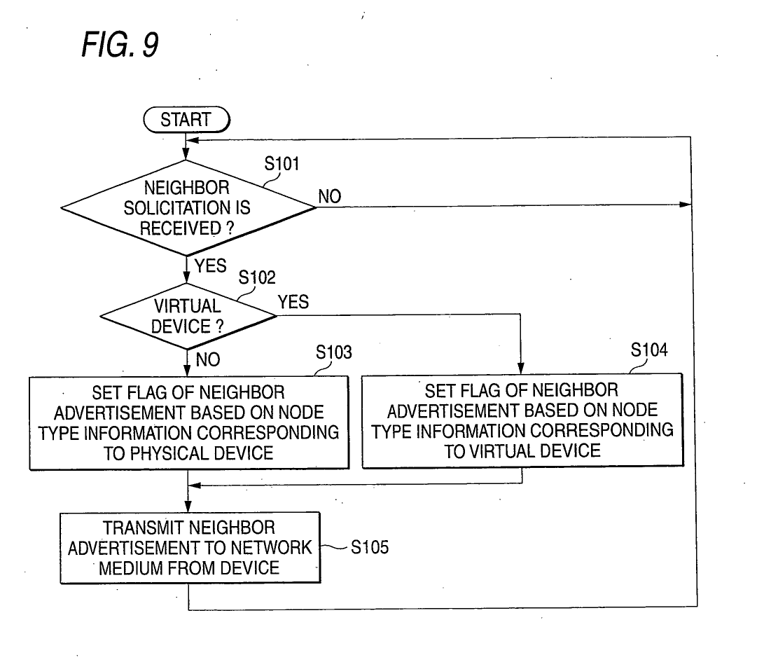

Here, the operation of the embodiment shown in FIG. 8 will be explained with use of FIG. 9. FIG. 9 is a flow diagram for describing the operation of a node as the multiple logical node apparatus.

In a step “S101” of FIG. 9, the node 9 (specifically, the OS 10) determines whether a neighbor solicitation is received. When the neighbor solicitation is received, in a step “S102”, the node 9 (specifically, the OS 10) determines whether or not the virtual network device 14 receives the neighbor solicitation.

In the step “S102” of FIG. 9, when it is determined that the physical network device 15 receives the neighbor solicitation, in a step “S103” of FIG. 9, the node 9 (specifically, the OS 10) sets a node indicator (IsRouter flag) of a neighbor advertisement on the basis of the node type information 18 corresponding to the physical network device 15.

In the step “S102” of FIG. 9, when it is determined that the virtual network device 14 receives the neighbor solicitation, in a step “S104” of FIG. 9, the node 9 (specifically, the OS 10) sets the node indicator (IsRouter flag) of the neighbor advertisement on the basis of the node type information 19 corresponding to the virtual network device 14.

Finally, in a step “S105” of FIG. 9, the node 9 (specifically, physical network device 15 or virtual network device 14) transmits the generated neighbor advertisement to the network medium 16.

As a result, the single physical network device is mounted on the single node. The physical network device is controlled by a first network driver incorporated in the OS through the network layer having first node type information. The virtual network device is controlled by a second network driver incorporated in the OS through the network layer having second node type information. The communication data from the virtual network device is transmitted to the network medium by utilizing only the communication function (communication section) for communicating with the network medium of the physical network device. Therefore, the communication data to which the arbitrary IP address and the arbitrary MAC address are attached for every physical network device or virtual network device can be transmitted to the network medium such as a communication cable.

Further, the node type information can be set in every physical network device or virtual network device, so that a plurality of logical nodes having different node type information can be developed, specifically, every logical node can serve as the host or router.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the attached claims and their equivalents.

What is claimed is:

1. A multiple logical node apparatus comprising:
an operating system operated in the multiple logical node apparatus;
an application operated under the operating system;
a physical network device for performing communication with a network medium, the physical network device being mounted on the multiple logical node apparatus;
at least one virtual network device implemented by software;
a first device driver for controlling the physical network device, the first device driver being incorporated in the operating system; and
at least one second device driver for controlling the virtual network device, the second device driver being incorporated in the operating system,
wherein a first process in the application selects the physical network device as a network device for transmitting communication data,
a second process in the application selects the virtual network device as a network device for transmitting communication data, and
the communication data from the virtual network device is transmitted to the network medium by using a communication section of the physical network device, the communication section communicating with the network medium.

2. The multiple logical node apparatus according to claim 1, comprising:
a plurality of pairs of the virtual network device and the second device driver.

3. The multiple logical node apparatus according to claim 1, wherein
a process in the application selects the physical network device or the virtual network device to transmit communication data,
the operating system attaches a unique IP (Internet Protocol) address of the selected physical network device or virtual network device, to a header of the communication data,
the first device driver attaches a unique MAC (Media Access Control) address of the physical network device to the header of the communication data when the physical network device is selected,
the second device driver attaches a unique MAC address of the virtual network device to the header of the communication data when the virtual network device is selected, and
the selected physical network device or virtual network device transmits the communication data to the network medium.

4. A multiple logical node apparatus comprising:
an operating system operated in the multiple logical node apparatus;
an application operated under the operating system;
a physical network device for performing communication with a network medium, the physical network device being mounted on the multiple logical node apparatus;
a first and a second virtual network device which are implemented by software;
a first device driver for controlling the first virtual network device, the first device driver being incorporated in the operating system; and
a second device driver for controlling the second virtual network device, the second device driver being incorporated in the operating system,
wherein a first process in the application selects the first virtual network device as a network device for transmitting communication data,
a second process in the application selects the second virtual network device as a network device for transmitting communication data, and
the communication data from the first and the second virtual network device are respectively transmitted to the network medium by using a communication section of the physical network device, the communication section communicating with the network medium.

5. The multiple logical node apparatus according to claim 4,
wherein a process in the application selects the first or the second virtual network device to transmit communication data,
the operating system attaches a unique IP (Internet Protocol) address of the selected first or second virtual network device, to a header of the communication data,
the first device driver attaches a unique MAC (Media Access Control) address of the first virtual network device to the header of the communication data when the first virtual network device is selected,
the second device driver attaches a unique MAC address of the second virtual network device to the header of the communication data when the second virtual network device is selected, and
the selected first or second virtual network device transmits the communication data to the network medium.

6. The multiple logical node apparatus according to claim 1, wherein
the first device driver is incorporated in the operating system through a network layer having first node type information, and
the second device driver is incorporated in the operating system through a network layer having second node type information.

7. The multiple logical node apparatus according to claim 6, comprising:
a plurality of pairs of the virtual network device and the second device driver.

8. The multiple logical node apparatus according to claim 6, wherein
the operating system determines whether the virtual network device receives a neighbor solicitation when the multiple logical node apparatus receives the neighbor solicitation,
the operating system sets a node type indicator (IsRouter flag) for a neighbor advertisement based on the first node type information corresponding to the physical network device when the operation system determines that the physical network device receives the neighbor solicitation,
the operating system sets the node type indicator (IsRouter flag) for the neighboring advertisement based on the second node type information corresponding to the virtual network device when the operation system determines that the virtual network device receives the neighbor solicitation, and
the physical network device or the virtual network device transmits the neighbor advertisement to the network medium.

9. The multiple logical node apparatus according to claim 4, wherein
the first device driver is incorporated in the operating system through a network layer having first node type information, and
the second device driver is incorporated in the operating system through a network layer having second node type information.

10. The multiple logical node apparatus according to claim 9, wherein
the operating system determines whether the first virtual network device receives a neighbor solicitation when the multiple logical node apparatus receives the neighbor solicitation,
the operating system sets a node type indicator (IsRouter flag) for a neighbor advertisement based on the first node type information corresponding to the first virtual network device when the operation system determines that the first virtual network device receives the neighbor solicitation,
the operating system sets the node type indicator (IsRouter flag) for the neighboring advertisement based on the second node type information corresponding to the second virtual network device when the operation system determines that the second virtual network device receives the neighbor solicitation, and
the first or the second virtual network device transmits the neighbor advertisement to the network medium.

11. The multiple logical node apparatus according to claim 1, wherein
the application is executed in accordance with a model that includes:
a physical layer in an OSI (Open Systems Interconnection) reference model; and
a plurality of logical nodes being provided on a higher level of the physical layer, and
the plurality of logical nodes respectively serve as from an application layer to a data link layer in the OSI reference model, for every process in the application.

12. The multiple logical node apparatus according to claim 4, wherein
the application is executed in accordance with a model that includes:
a physical layer in an OSI (Open Systems Interconnection) reference model; and
a plurality of logical nodes being provided on a higher-level of the physical layer, and
the plurality of logical nodes respectively serve as from an application layer to a data link layer in the OSI reference model, for every process in the application.

13. The multiple logical node apparatus according to claim 6, wherein
the application is executed in accordance with a model that includes:
a physical layer in an OSI (Open Systems Interconnection) reference model; and
a plurality of logical nodes being provided on a higher-level of the physical layer, and
the plurality of logical nodes respectively serve as from an application layer to a data link layer in the OSI reference model, for every process in the application.

14. The multiple logical node apparatus according to claim 9, wherein
the application is executed in accordance with a model that includes:
a physical layer in an OSI (Open Systems Interconnection) reference model; and
a plurality of logical nodes being provided on a higher-level of the physical layer, and
the plurality of logical nodes respectively serve as from an application layer to a data link layer in the OSI reference model, for every process in the application.
